(19) United States
(12) Patent Application Publication
(10) Pub. No.: US 2015/0185405 A1
(43) Pub. Date: Jul. 2, 2015

(54) LASER DIODE LIGHT SOURCE AND BACKLIGHT MODULE INCORPORATING THE SAME

(71) Applicant: HON HAI PRECISION INDUSTRY CO., LTD., New Taipei (TW)

(72) Inventor: CHEN-HAN LIN, New Taipei (TW)

(21) Appl. No.: 14/512,572

(22) Filed: Oct. 13, 2014

(30) Foreign Application Priority Data
Dec. 30, 2013 (TW) 102149053

(51) Int. Cl. F21V 8/00; F21K 99/00

(52) U.S. Cl. CPC G02B 6/0068; F21K 9/50; G02B 6/003; G02B 6/002; G02B 6/0043

(57) ABSTRACT

A laser diode (LD) light source includes a laser diode array including a plurality of red, blue and green laser diodes, and an optical lens array optically coupled to the laser diode array. The optical lens array includes a plurality of cylindrical lenses, and each cylindrical lens corresponding to one of the red, blue, and green laser diodes. Light emitted from the red, blue and green laser diodes is respectively diverged by the corresponding cylindrical lenses in a lateral direction thereof. A backlight module incorporating the laser diode light source is also provided.

### FIELD

The subject matter herein generally relates to a laser diode (LD) light source, and a backlight module incorporating the laser diode light source.

### BACKGROUND

Laser diodes are widely used as light sources, which have high monochromaticity, small divergence angle, and high brightness compared to other conventional light sources, such as cold cathode fluorescent tubes, that are generally employed in a conventional backlight module for illuminating a liquid crystal display (LCD) screen.

### BRIEF DESCRIPTION OF THE DRAWINGS

Implementations of the present technology will now be described, by way of example only, with reference to the attached figures.

FIG. 1 is a top perspective, partial cutaway view of a backlight module in accordance with a first embodiment of the present disclosure.

FIG. 2 is a right-side, cutaway view of the backlight module of FIG. 1.

FIG. 3 is a right-side, cutaway view of a backlight module in accordance with a second embodiment of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

The present disclosure is described in relation to a laser diode light source, and a backlight module incorporating the laser diode light source.

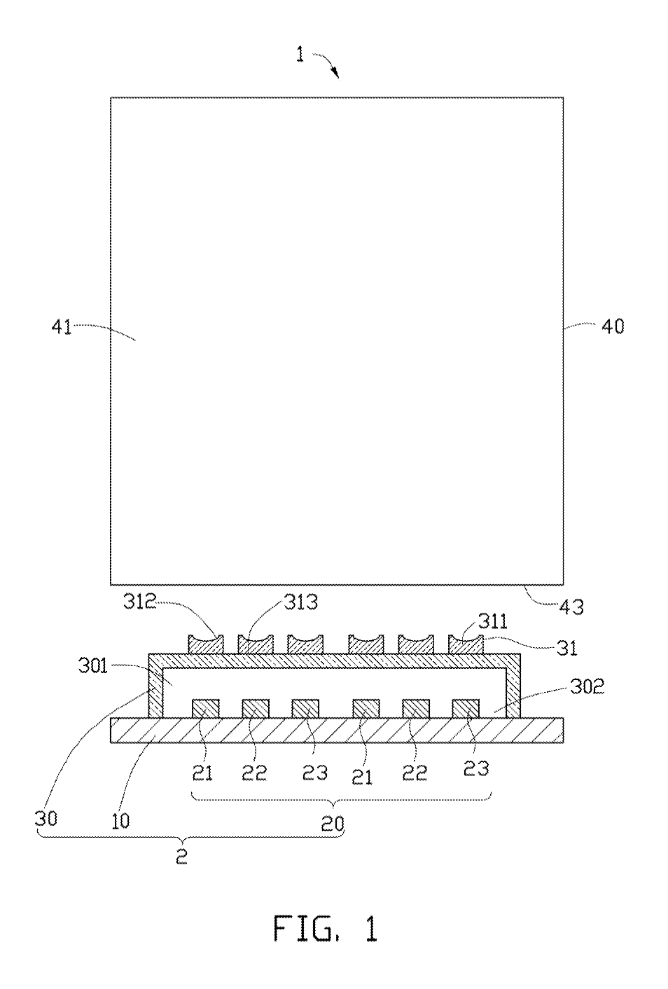

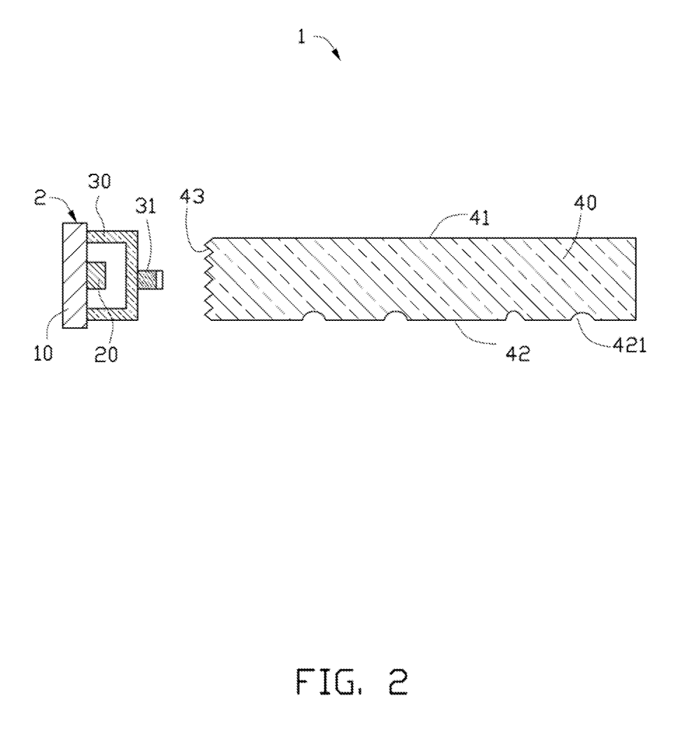

Referring to FIGS. 1 and 2, a backlight module 1 in accordance with a first embodiment of the present disclosure is illustrated. The backlight module 1 includes a laser diode light source 2 and a light guide plate 40 optically coupled to the laser diode light source 2. The laser diode light source 2 is located at a side of the light guide plate 40. The laser diode light source 2 includes a base 10, a laser diode array 20 arranged on the base 10, a light transmissive cover 30 fixed to the base 10 and covering the laser diode array 20, and an optical lens array 31 arranged on the light transmissive cover 30 for optically coupling light emitted from the laser diode array 20 into the light guide plate 40.

The laser diode array 20 includes a plurality of red, blue and green laser diodes 21, 22, and 23, respectively. The plurality of red, blue, and green laser diodes 21, 22, 23 are alternately arranged on the base 10 along a lengthwise direction thereof.

The optical lens array 31 includes a plurality of cylindrical lenses 311. Each cylindrical lens 311 corresponds to one of the red, blue, and green laser diodes 21, 22, 23. Each cylindrical lens 311 is aligned with the corresponding one of the red, blue, and green laser diodes 21, 22, 23. Each cylindrical lens 311 includes a top surface 312 and a bottom surface 313 at opposite sides thereof. The top surface 312 of the cylindrical lens 311 facing away from the laser diode array 20 is recessed inwardly toward the bottom surface 313. Light emitted from the red, blue and green laser diodes 21, 22, and 23 is respectively diverged by the corresponding cylindrical lenses 311 in a lateral direction thereof, i.e., a left-to-right direction in FIG. 1. In detail, light emitted from the red, blue and green laser diodes 21, 22, and 23 enters the corresponding cylindrical lenses 311, and is refracted out of the corresponding cylindrical lenses 311 through the top surface 312 toward a lateral direction thereof, respectively. Accordingly, red, blue, and green light that passes through the corresponding cylindrical lens 311 is mixed along a lateral direction of the corresponding cylindrical lens 311 to generate a mixed white light.

The optical lens array 31 is disposed above the laser diode array 20 and separated from the laser diode array 20 by the light transmissive cover 30. The light transmissive cover 30 is located between the laser diode array 20 and the optical lens array 31. The light transmissive cover 30 has a box-shaped configuration with an opening 302 formed at a bottom thereof. The light transmissive cover 30 defines a receiving cavity 301 therein, and the laser diode array 20 is placed into the receiving cavity 301 via the opening 302. In the present embodiment, the light transmissive cover 30 is firmly secured to the base 10 via gluing or fasteners.

The light guide plate 40 is a rectangular-shaped structure. The light guide plate 40 includes a light incident face 43 located at a side thereof, and a light exit face 41 located at a top side thereof. The light guide plate 40 further includes a bottom face 42 opposite to the light exit face 41 and adjacent to the light incident face 43.

The light incident face 43 is zigzag-shaped in cross section. The light that is emitted from the laser diode array 20 and strikes the light incident face 43 is diverged by the light incident face 43 of the light guide plate 40 along a thickness direction thereof. In detail, the light emitted from the plurality of red, blue, and green laser diodes 21, 22, 23 is sufficiently mixed inside the light guide plate 40 along a thickness direction thereof, thereby generating a white light having a high color rendering index.

The bottom face 42 includes a plurality of micro-pits 421 formed thereon. A part of the light that enters the light guide plate 40 and strikes the bottom face 42 is first reflected by the bottom face 42 toward the opposite light exit face 41 and then refracted out of the light guide plate 40 through the light exit face 41. The plurality of micro-pits 421 can diffuse light that strikes on an inner side thereof, thereby generating a uniform light distribution inside the light guide plate 40. Alternatively, a plurality of microstructures in a nanometer scale, such as micro-dots, can be formed on the bottom face 42, so as to diffuse a part of the light that strikes the bottom face 42.

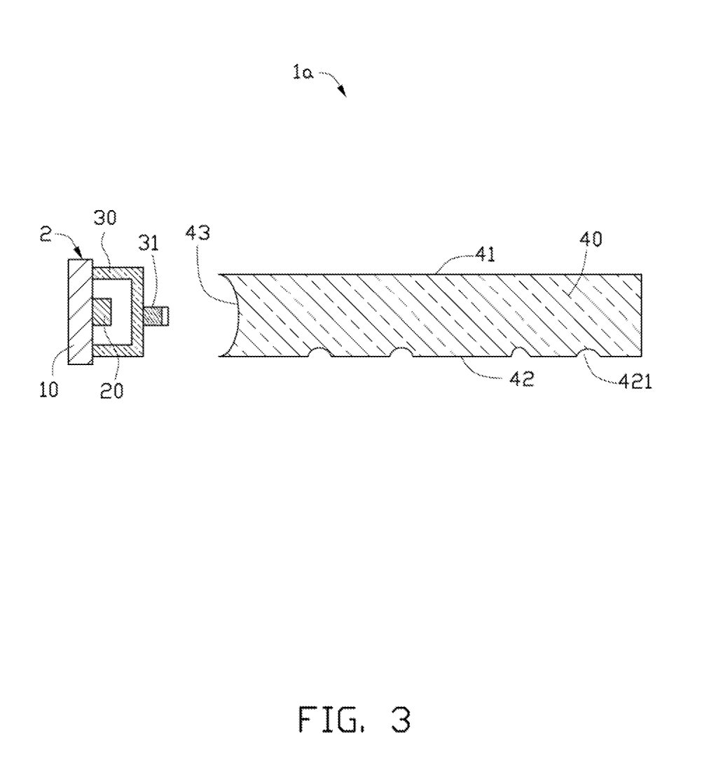

Referring to FIG. 3, a backlight module la in accordance with a second embodiment is illustrated. The backlight module la includes a laser diode light source 2, and a light guide plate 40 optically coupled to the laser diode light source 2. Different from the backlight module 1 shown in FIG. 2, a light incident face 43 of light guide plate 40 in FIG. 3 is arc-shaped in cross section. The light that is emitted from the laser diode array 20 and strikes the light incident face 43 is diverged by the light incident face 43 of the light guide plate 40 along a thickness direction thereof. In detail, the light incident face 43 is a concave surface.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments.

What is claimed is:

1. A laser diode (LD) light source, comprising:
a laser diode array comprising a plurality of red, blue and green laser diodes; and
an optical lens array optically coupled to the laser diode array, the optical lens array comprising a plurality of cylindrical lenses, and each cylindrical lens corresponding to one of the red, blue, and green laser diodes;
wherein light emitted from the red, blue and green laser diodes is diverged by the corresponding cylindrical lenses in a lateral direction thereof.

2. The LD light source of claim 1, wherein each cylindrical lens is aligned with the corresponding one of the red, blue, and green laser diodes.

3. The LD light source of claim 1, wherein each cylindrical lens comprises a top surface and a bottom surface at opposite sides thereof, and the top surface of the cylindrical lens facing away from the laser diode array is recessed inwardly toward the bottom surface.

4. The LD light source of claim 1, wherein the optical lens array is disposed above the laser diode array and spaced from the laser diode array.

5. The LD light source of claim 4, further comprising a light transmissive cover located between the laser diode array and the optical lens array, the optical lens array being separated from the laser diode array by the light transmissive cover.

6. The LD light source of claim 5, wherein the light transmissive cover has a box-shaped configuration with an opening formed at a bottom thereof, the light transmissive cover defines a receiving cavity, and the laser diode array is placed into the receiving cavity via the opening of the light transmissive cover.

7. The LD light source of claim 6, further comprising a base on which the laser diode array is arranged, and the light transmissive cover being firmly secured to the base.

8. The LD light source of claim 7, wherein the plurality of red, blue and green laser diodes are alternately arranged on the base along a lengthwise direction thereof.

9. A backlight module, comprising a light guide plate and a laser diode light source, the light guide plate being generally shaped like a rectangular parallelepiped and comprising a light incident face located at a side thereof, and a light exit face located at a top side thereof;
the laser diode light source comprising:
a laser diode array comprising a plurality of red, blue and green laser diodes;
and an optical lens array optically coupled to the laser diode array, the optical lens array comprising a plurality of cylindrical lenses, each cylindrical lens corresponding to one of the red, blue, and green laser diodes;
wherein light emitted from the red, blue and green laser diodes is respectively diverged by the corresponding cylindrical lenses in a lateral direction thereof, and the light enters into the light guide plate from the light incident face thereof.

10. The backlight module of claim 9, wherein the light guide plate further comprises a bottom face adjoining the light incident face and parallel with the light exit face, the bottom face comprises a plurality of micro-pits thereon, and at least a part of the light that enters the light guide plate and strikes the bottom face is first reflected by the bottom face toward the opposite light exit face and then refracted out of the light guide plate therethrough.

11. The backlight module of claim 9, wherein the light incident face is zigzag-shaped in cross section, the light that is emitted from the laser diode array and strikes the light incident face is diverged by the light incident face of the light guide plate along a thickness direction thereof.

12. The backlight module of claim 9, wherein the light incident face is arc-shaped in cross section, the light that is emitted from the laser diode array and strikes the light incident face is diverged by the light incident face of the light guide plate along a thickness direction thereof.

13. The backlight module of claim 9, wherein each cylindrical lens is aligned with the corresponding one of the red, blue, and green laser diodes.

14. The backlight module of claim 9, wherein each cylindrical lens comprises a top surface and a bottom surface at opposite sides thereof, and the top surface of the cylindrical lens facing away from the laser diode array is recessed inwardly toward the bottom surface.

15. The backlight module of claim 9, wherein the optical lens array is disposed above the laser diode array and spaced from the laser diode array.

16. The backlight module of claim 15, further comprising a light transmissive cover located between the laser diode array and the optical lens array, the optical lens array being separated from the laser diode array by the light transmissive cover.

17. The backlight module of claim 16, wherein the light transmissive cover has a box-shaped configuration with an opening formed at a bottom thereof, the light transmissive cover defines a receiving cavity, and the laser diode array is placed into the receiving cavity via the opening of the light transmissive cover.

18. The backlight module of claim 16, further comprising a base on which the laser diode array is arranged, and the light transmissive cover being firmly secured to the base.

19. The backlight module of claim 18, wherein the plurality of red, blue and green laser diodes are alternately arranged on the base along a lengthwise direction thereof.

20. The backlight module of claim 9, wherein the light exit face is substantially perpendicular to the light incident face, and the light guide plate is optically coupled to the optical lens array with the light incident face positioned facing the optical lens array.
